(19) United States
(12) Patent Application Publication
(10) Pub. No.: US 2025/0226879 A1
(43) Pub. Date: Jul. 10, 2025

(54) COMMUNICATION APPARATUS ACTIVATION METHOD, WIRELESS COMMUNICATION SYSTEM AND WIRELESS COMMUNICATION APPARATUS

(71) Applicant: NIPPON TELEGRAPH AND TELEPHONE CORPORATION, Tokyo (JP)

(72) Inventors: Kazumitsu SAKAMOTO, Musashino-shi (JP); Yosuke FUJINO, Musashino-shi (JP); Kenji SUZUKI, Musashino-shi (JP); Yasuyoshi KOJIMA, Musashino-shi (JP); Kiyohiko ITOKAWA, Musashino-shi (JP)

(73) Assignee: NIPPON TELEGRAPH AND TELEPHONE CORPORATION, Tokyo (JP)

(21) Appl. No.: 18/854,607

(22) PCT Filed: Apr. 21, 2022
(86) PCT No.: PCT/JP2022/018471

§ 371 Date: Oct. 7, 2024

(51) Int. Cl. H04B 7/185; H04B 7/195

(52) U.S. Cl. CPC H04B 7/18539; H04B 7/1855; H04B 7/195

(57) ABSTRACT

A communication device activation method performed by a wireless communication system including one or more communication devices installed on a ground and a wireless communication device that moves includes an activation signal generation step of generating an activation signal for activating the one or more communication devices, a frequency variation application step of applying, to the activation signal generated by the activation signal generation step, a frequency variation that compensates for a Doppler variation indicating a time variation in a Doppler shift that occurs in the activation signal, and a transmission step of transmitting the activation signal to which the frequency variation is applied by the frequency variation application step from the wireless communication device to the one or more communication devices.

### TECHNICAL FIELD

The present invention relates to a communication apparatus activation method, a wireless communication system, and a wireless communication apparatus.

### BACKGROUND ART

With the development of Internet of Things (IoT) technology, installing IoT terminals including various sensors in various places has been studied. The IoT terminals may be installed in places where it is difficult to install a base station, such as a buoy or a ship on the sea or a mountainous area. In view of this, a wireless communication system has been proposed in which data collected by IoT terminals installed in various places is relayed to a base station installed on the ground via a relay device mounted on a low earth orbit satellite.

Since the IoT terminal is driven by the power supplied from batteries, it is necessary to operate the IoT terminal with power saving in order to extend the battery life. Therefore, in the satellite sensing platform, in order to realize the battery life of the IoT terminal in units of years, it is desirable that the IoT terminal is activated and uplink transmits data when detecting that a low earth orbit satellite arrives in the sky. To detect that a low earth orbit satellite arrives in the sky in the IoT terminal, means for observing a downlink signal from the low earth orbit satellite to the ground is considered (for example, refer to Non Patent Literature 1).

### CITATION LIST

### Non Patent Literature

Non Patent Literature 1: F. Shu, X. Zhang, T. Kondo, “Development of correlator model for differential VLBI observations of satellites”, 2008 International Conference on Microwave and Millimeter Wave Technology, ICMMT2008 Proceedings, Vol. 1, pp. 443-446, April 2008.

### SUMMARY OF INVENTION

### Technical Problem

However, since the low earth orbit satellite moves at a high speed, a time variation (hereinafter referred to as “Doppler variation”) of the Doppler shift occurs in the downlink signal transmitted from the low earth orbiting satellite. Therefore, there is a case where Doppler variation with a variation amount exceeding a demodulable range of the downlink signal occurs, depending on the positional relationship between the low earth orbit satellite and the IoT terminal at a certain time point. In such a case, since the IoT terminal cannot demodulate the downlink signal even if a reception level of the downlink signal is sufficiently high, there is a problem that the IoT terminal may not be activated. Such a problem similarly occurs not only in signals transmitted from the low earth orbit satellite but also in signals transmitted from various wireless communication devices moving in the sky.

In view of the above circumstances, an object of the present invention is to provide a technology of capable of activating a communication device installed on the ground even when a Doppler variation occurs in an activation signal transmitted from a wireless communication device moving in the sky.

### Solution to Problem

One aspect of the present invention is a communication device activation method performed by a wireless communication system including one or more communication devices installed on a ground and a wireless communication device that moves, and is a communication device activation method including: an activation signal generation step of generating an activation signal for activating the one or more communication devices; a frequency variation application step of applying, to the activation signal generated by the activation signal generation step, a frequency variation that compensates for a Doppler variation indicating a time variation in a Doppler shift that occurs in the activation signal; and a transmission step of transmitting the activation signal to which the frequency variation is applied by the frequency variation application step from the wireless communication device to the one or more communication devices.

One aspect of the present invention is a wireless communication system including one or more communication devices installed on a ground and a wireless communication device that moves, the wireless communication device including: an activation signal generation unit configured to generate an activation signal for activating the one or more communication devices; a frequency variation application unit configured to apply, to the activation signal generated by the activation signal generation unit, a frequency variation that compensates for a time variation in a Doppler shift that occurs in the activation signal; and a transmission unit configured to transmit the activation signal to which the frequency variation is applied by the frequency variation application unit, and the communication device including: a reception unit configured to receive the activation signal transmitted from the wireless communication device; and an activation control unit configured to cause an own device to be in an activated state according to the activation signal received by the reception unit.

One aspect of the present invention is a wireless communication device in a wireless communication system including one or more communication devices installed on a ground and the wireless communication device that moves, the wireless communication device including: an activation signal generation unit configured to generate an activation signal for activating the one or more communication devices; a frequency variation application unit configured to apply, to the activation signal generated by the activation signal generation unit, a frequency variation that compensates for a time variation in a Doppler shift that occurs in the activation signal; and a transmission unit configured to transmit the activation signal to which the frequency variation is applied by the frequency variation application unit.

### Advantageous Effects of Invention

According to the present invention, even when a Doppler variation occurs in an activation signal transmitted from a wireless communication device moving in the sky, a communication device installed on the ground can be activated.

### BRIEF DESCRIPTION OF DRAWINGS

FIG. 1 is a schematic diagram for describing a configuration of a wireless communication system 1 according to a first embodiment of the present invention.

FIG. 2 is graphs illustrating a relationship between an elevation angle and a Doppler variation amount in a case where a mobile relay station 2 does not apply a frequency variation to an activation signal.

FIG. 3 is graphs illustrating a relationship between an elevation angle and a Doppler variation amount in a case where the mobile relay station 2 applies a frequency variation in a variation amount of “a maximum Doppler variation amount−Doppler shift tolerance” to the activation signal.

FIG. 4 is graphs illustrating a relationship between an elevation angle and a Doppler variation amount in a case where the mobile relay station 2 applies a frequency variation in a variation amount of “the maximum Doppler variation amount−the Doppler shift tolerance×3” to the activation signal.

FIG. 5 is graphs illustrating a relationship between an elevation angle and a Doppler variation amount in a case where the mobile relay station 2 applies a frequency variation in a variation amount of “the maximum Doppler variation amount−the Doppler shift tolerance ×5” to the activation signal.

FIG. 6 is a block diagram illustrating a functional configuration of the wireless communication system 1 according to the first embodiment of the present invention.

FIG. 7 is a table illustrating an example of an application table 233 according to the first embodiment of the present invention.

FIG. 8 is a flowchart illustrating a flow of activation processing for a terminal station 3 performed by the mobile relay station 2 according to the first embodiment of the present invention.

FIG. 9 is a flowchart illustrating a flow of the activation processing of the terminal station 3 according to the first embodiment of the present invention.

FIG. 10 is a schematic diagram for describing a relationship between transmission timing of the activation signal and an activatable area by the wireless communication system 1 according to the first embodiment of the present invention.

FIG. 11 is a schematic diagram for describing a relationship between the transmission timing of the activation signal and transmission timing of a terminal uplink signal by the wireless communication system 1 according to the first embodiment of the present invention.

FIG. 12 is a schematic diagram for describing a relationship between the transmission timing of the activation signal and the activatable area by the wireless communication system 1 according to a modification of the first embodiment of the present invention.

FIG. 13 is a schematic diagram for describing a relationship between the transmission timing of the activation signal and the transmission timing of the terminal uplink signal by the wireless communication system 1 according to the modification of the first embodiment of the present invention.

FIG. 14 is a schematic diagram for describing a configuration of a wireless communication system 1a according to a second embodiment of the present invention.

FIG. 15 is a graph illustrating an example of a relationship between a position of a mobile relay station 2a with respect to a terminal station 3 and a Doppler shift.

FIG. 16 is a block diagram illustrating a functional configuration of the wireless communication system 1a according to the second embodiment of the present invention.

FIG. 17 is a flowchart illustrating a flow of activation processing for the terminal station 3 performed by the mobile relay station 2a according to the second embodiment of the present invention.

### DESCRIPTION OF EMBODIMENTS

Hereinafter, a communication apparatus activation method, a wireless communication system, and a wireless communication apparatus according to an embodiment of the present invention will be described with reference to the drawings.

### First Embodiment

### Configuration of Wireless Communication System

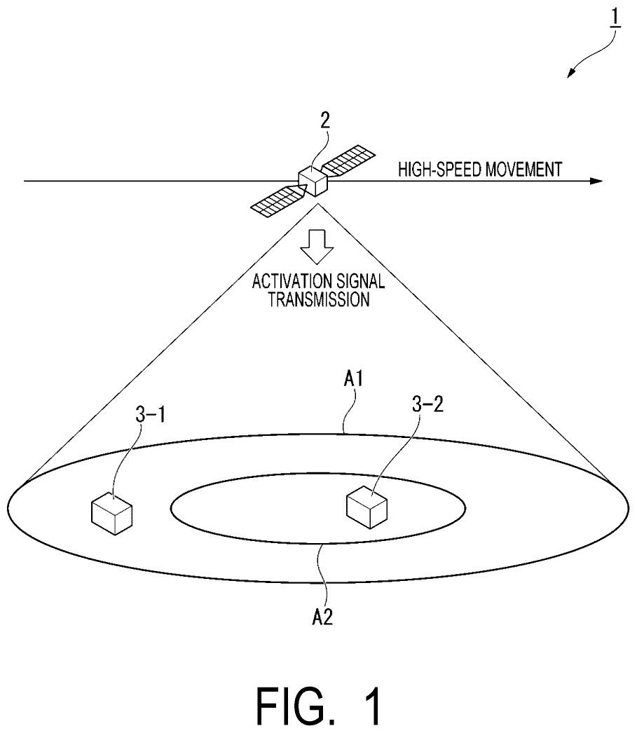

Hereinafter, a configuration of a wireless communication system 1 according to a first embodiment will be described. FIG. 1 is a schematic diagram for describing a configuration of a wireless communication system 1 according to the first embodiment of the present invention.

As illustrated in FIG. 1, the wireless communication system 1 in the first embodiment includes at least a mobile relay station 2, and one or more terminal stations 3. FIG. 1 illustrates a case where there are two terminal stations 3-1 and 3-2 as an example.

Since the mobile relay station 2 moves at a high speed, a Doppler variation may occur when an activation signal transmitted from the mobile relay station 2 is received by the terminal station 3 disposed on the ground. The activation signal referred to here is a downlink signal for activating the terminal station 3, which is transmitted from the mobile relay station 2 moving in the sky toward the ground. In addition, the Doppler variation referred to here is a time variation in a Doppler shift obtained by differentiating the Doppler shift. When the Doppler variation occurs in the activation signal, the terminal station 3 existing at a position outside an allowable range of the Doppler variation may not be able to demodulate and decode the activation signal. The terminal station 3 existing at a position outside the allowable range of the Doppler variation is the terminal station 3 when the position of the mobile relay station 2 is in a positional relationship of a high elevation angle as viewed from the position of the terminal station 3.

Therefore, as illustrated in FIG. 1, an area on the ground outside the allowable range of the Doppler variation is a range centered on the position directly below the mobile relay station 2. FIG. 1 illustrates an area A1 that is an area in which the terminal station 3 can receive the activation signal transmitted from the mobile relay station 2, and an area A2 that is out of the allowable range of the Doppler variation in the area A1.

For example, in FIG. 1, the terminal station 3-1 is located in the area A1 and outside the area A2. Therefore, the terminal station 3-1 is located in an allowable range of the Doppler variation, and can demodulate and decode the activation signal transmitted from the mobile relay station 2. On the other hand, in FIG. 1, the terminal station 3-2 is located in the area A2. Therefore, the terminal station 3-2 is located outside the allowable range of the Doppler variation, and cannot demodulate and decode the activation signal transmitted from the mobile relay station 2.

Therefore, the mobile relay station 2 in the first embodiment applies a frequency variation in a variation amount that cancels (compensates for) such a Doppler variation to the activation signal in advance. Then, the mobile relay station 2 transmits the activation signal to which the frequency variation is applied to the ground. An applied variation amount of the frequency variation is calculated on the basis of the elevation angle of the mobile relay station 2 viewed from the position of the terminal station 3, or the like. The mobile relay station 2 calculates the variation amount (hereinafter referred to as a “Doppler variation amount”) of the generated Doppler variation on the basis of the elevation angle and the like, and applies the frequency variation of the variation amount that cancels the calculated Doppler variation amount to the activation signal.

Hereinafter, as an example, a case where the allowable range of the variation amount of the Doppler variation for enabling the terminal station 3 to demodulate and decode the activation signal is −15 to 15 [Hz/s] will be described. That is, if the variation amount of the Doppler variation caused in the activation signal transmitted from the mobile relay station 2 is within the range of −15 to 15 [Hz/s], the terminal station 3 can demodulate and decode the activation signal.

In addition, in the following description, such a variation range (here, a variation range of 15 [Hz/s]) of the Doppler variation that enables the terminal station 3 to demodulate and decode the activation signal is referred to as “Doppler shift tolerance”. The mobile relay station 2 applies the frequency variation in the variation amount calculated by “the maximum Doppler variation amount−the Doppler shift tolerance” to the activation signal.

For example, in a case where the altitude of the mobile relay station 2 is 570 [km] and the activation signal is in a 400 [MHz] band, the Doppler variation amount in the vicinity directly below the mobile relay station 2, which is a point where the variation range of the Doppler variation amount is maximized, is about 134 [Hz/s]. As described above, the mobile relay station 2 applies the frequency variation of “the maximum Doppler variation amount−the Doppler shift tolerance” to the activation signal. That is, in this case, the mobile relay station 2 applies the frequency variation of 119 [Hz/s] (=134−15) to the activation signal. The mobile relay station 2 applies the frequency variation of 119 [Hz/s] to the activation signal and transmits the activation signal, so that the terminal station 3 located directly below and around the mobile relay station 2 can demodulate and decode the activation signal.

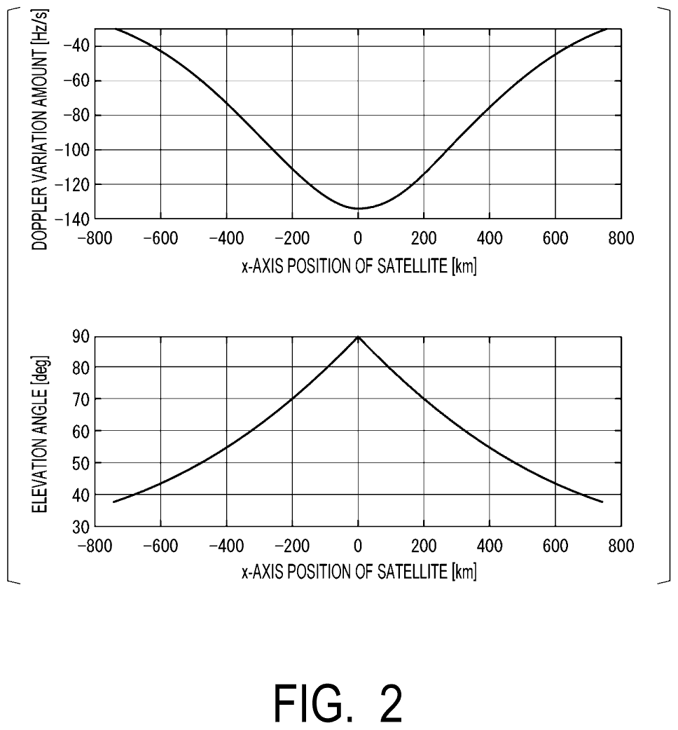

FIG. 2 is graphs illustrating a relationship between an elevation angle and a Doppler variation amount in a case where a mobile relay station 2 does not apply a frequency variation to an activation signal. Note that, as described above, the elevation angle referred to here is the elevation angle of the mobile relay station 2 viewed from the position of the terminal station 3.

In the graph illustrated in the upper part of FIG. 2, the horizontal axis represents an x-axis position (unit: km) of the mobile relay station 2, and the vertical axis represents the Doppler variation amount (unit: Hz/s). The x-axis position of the mobile relay station 2 referred to here indicates a distance from a point directly below a specific position on a go-around orbit of the mobile relay station 2 (for example, a point where the terminal station 3 exists) to a point directly below a position where the mobile relay station 2 actually exists. In the upper graph of FIG. 2, the case where the x-axis position of the mobile relay station 2 is 0 [km] is a case where the position of the mobile relay station 2 is directly above the specific point (for example, the point where the terminal station 3 exists). That is, the elevation angle at this time is 90 [deg]. As illustrated in the upper graph of FIG. 2, in the case where the x-axis position of the mobile relay station 2 is 0 [km], the variation range of the Doppler variation amount is maximized and is about −134 [Hz/s].

In addition, as illustrated in the upper graph of FIG. 2, even when the x-axis position of the mobile relay station 2 is −600 [km] or 600 [km], the Doppler variation amount is less than −40 [Hz/s] and does not fall within the Doppler tolerance range (within −15 to 15 [Hz/s]). Therefore, the terminal station 3 may not be able to demodulate and decode the activation signal even at a point having the above-described positional relationship with the position of the mobile relay station 2 (that is, a point where the x-axis position of the mobile relay station 2 is −600 [km] or 600 [km].) That is, it is known that if the position of the mobile relay station 2 is not further away from the position of the terminal station 3 (that is, unless the position of the mobile relay station 2 is located at a lower elevation angle), the terminal station 3 may not be able to demodulate and decode the activation signal.

In the graph illustrated in the lower part of FIG. 2, the horizontal axis represents the x-axis position (unit: km) of the mobile relay station 2, and the vertical axis represents the elevation angle (unit: deg). As illustrated in the lower graph of FIG. 2, the case where the x-axis position of the mobile relay station 2 is 0 [km] is the case where the position of the mobile relay station 2 is directly above the specific point, and thus the elevation angle is 90 [deg].

For example, by comparing the upper graph and the lower graph in FIG. 2, it can be seen that the x-axis position of the mobile relay station 2 is about −700 [km] or 700 [km] when the elevation angle when the mobile relay station 2 is viewed from the position of the terminal station 3 is about 40 [deg]. Therefore, even if the elevation angle when the mobile relay station 2 is viewed from the position of the terminal station 3 is about 40 [deg], the Doppler variation amount does not fall within the Doppler tolerance range (within −15 to 15 [Hz/s]), and it can be seen that the terminal station 3 cannot demodulate and decode the activation signal in some cases.

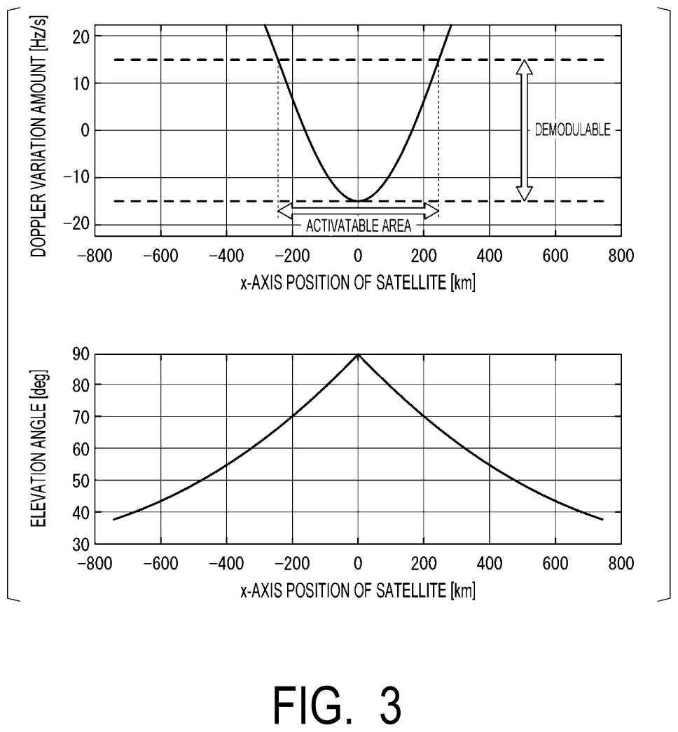

FIG. 3 is graphs illustrating a relationship between an elevation angle and a Doppler variation amount in a case where the mobile relay station 2 applies a frequency variation in the variation amount of “the maximum Doppler variation amount-the Doppler shift tolerance” to the activation signal. That is, FIG. 3 illustrates a relationship between the elevation angle and the Doppler variation amount in a case where the mobile relay station 2 applies the frequency variation of 119 [Hz/s] (=134−15) to the activation signal. Note that, as described above, the elevation angle referred to here is the elevation angle of the mobile relay station 2 viewed from the position of the terminal station 3.

In the graph illustrated in the upper part of FIG. 3, the horizontal axis represents the x-axis position (unit: km) of the mobile relay station 2, and the vertical axis represents the Doppler variation amount (unit: Hz/s). As illustrated in the upper graph of FIG. 3, in a case where the x-axis position of the mobile relay station 2 is within the range of about −200 to 200 [km], it can be seen that the Doppler variation amount falls within the range of −15 to 15 [Hz/s]. That is, it can be seen that the terminal station 3 existing at a point where the x-axis position of the mobile relay station 2 is within the range of about −200 to 200 [km] can demodulate and decode the activation signal.

In addition, as described above, in the case where the activation signal to which the frequency variation in the variation amount of 119 [Hz/s] is applied is used, it can be seen that the range on the ground where the x-axis position of the mobile relay station 2 is within the range of about −200 to 200 [km] is the activatable area of the terminal station 3. Note that the graph illustrated in the lower part of FIG. 3 is the same as the graph illustrated in the lower part of FIG. 2, and illustrates the relationship between the x-axis position of the mobile relay station 2 and the elevation angle.

Further, the mobile relay station 2 time-divisionally transmits the activation signals to which the frequency variations in different variation amounts are applied. For example, the mobile relay station 2 generates the activation signal to which the frequency variation in the variation amount of “the maximum Doppler variation amount−the Doppler shift tolerance×3” is applied and the activation signal to which the frequency variation in the variation amount of “the maximum Doppler variation amount−the Doppler shift tolerance×5” is applied, and time-divisionally transmit the activation signals, in addition to the above-described activation signal to which the frequency variation in the variation amount of “the maximum Doppler variation amount−the Doppler shift tolerance” is applied. As described above, the mobile relay station 2 performs time-division transmission of switching and transmitting, at predetermined intervals, the plurality of types of activation signals to which the frequency variation in the variation amount is applied, the variation amount being calculated by subtracting an odd multiple value of the Doppler shift tolerance from the maximum Doppler variation amount.

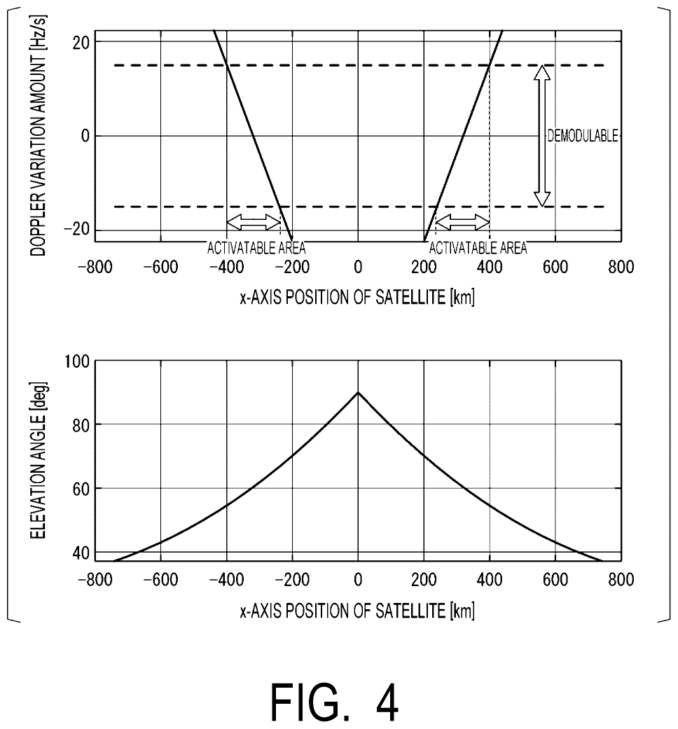

FIG. 4 is graphs illustrating a relationship between the elevation angle and the Doppler variation amount in a case where the mobile relay station 2 applies the frequency variation in the variation amount of “the maximum Doppler variation amount−the Doppler shift tolerance×3” to the activation signal. That is, FIG. 4 illustrates a relationship between the elevation angle and the Doppler variation amount in a case where the mobile relay station 2 applies the frequency variation of 89 [Hz/s] (=134−45) to the activation signal. Note that, as described above, the elevation angle referred to here is the elevation angle of the mobile relay station 2 viewed from the position of the terminal station 3.

In the graph illustrated in the upper part of FIG. 4, the horizontal axis represents the x-axis position (unit: km) of the mobile relay station 2, and the vertical axis represents the Doppler variation amount (unit: Hz/s). As illustrated in the upper graph of FIG. 4, in cases where the x-axis position of the mobile relay station 2 falls within the range of about −400 to −200 [km] and the range of about 200 to 400 [km], it can be seen that the Doppler variation amount falls within the range of −15 to 15 [Hz/s]. That is, it can be seen that the terminal station 3 existing at points where the x-axis position of the mobile relay station 2 is within the range of about −400 to −200 [km] and within the range of about 200 to 400 [km] can demodulate and decode the activation signal.

In addition, in the case where the activation signal to which the frequency variation in the variation amount of 89 [Hz/s] is applied is used, as described above, it can be seen that the ranges on the ground where the x-axis position of the mobile relay station 2 is within the range of about −400 to −200 [km] and within the range of about 200 to 400 [km] are the activatable areas of the terminal station 3. Note that the graph illustrated in the lower part of FIG. 4 is the same as the graphs illustrated in the lower part of FIG. 2 and the lower part of FIG. 3, and illustrates the relationship between the x-axis position of the mobile relay station 2 and the elevation angle.

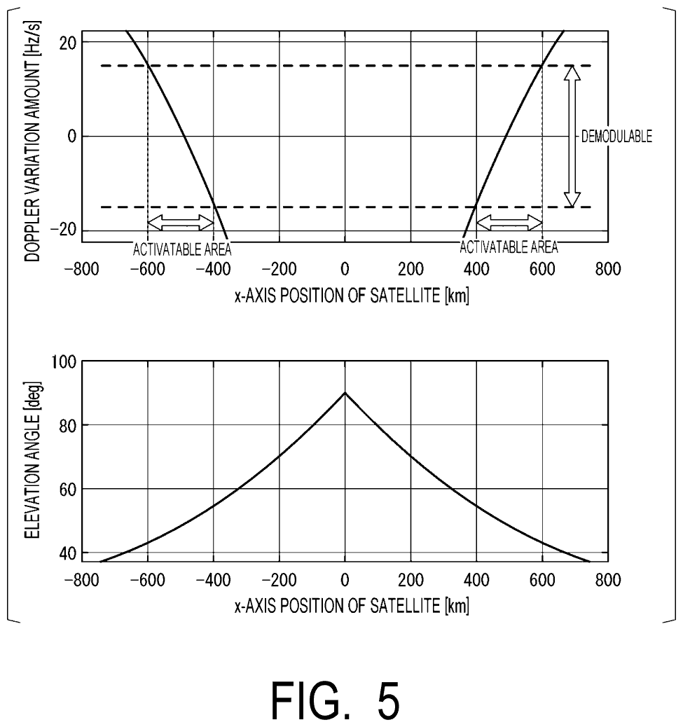

FIG. 5 is graphs illustrating a relationship between the elevation angle and the Doppler variation amount in a case where the mobile relay station 2 applies the frequency variation in the variation amount of “the maximum Doppler variation amount−the Doppler shift tolerance×5” to the activation signal. That is, FIG. 5 illustrates a relationship between the elevation angle and the Doppler variation amount in a case where the mobile relay station 2 applies the frequency variation of 59 [Hz/s] (=134−75) to the activation signal. Note that, as described above, the elevation angle referred to here is the elevation angle of the mobile relay station 2 viewed from the position of the terminal station 3.

In the graph illustrated in the upper part of FIG. 5, the horizontal axis represents the x-axis position (unit: km) of the mobile relay station 2, and the vertical axis represents the Doppler variation amount (unit: Hz/s). As illustrated in the upper graph of FIG. 5, in cases where the x-axis position of the mobile relay station 2 falls within the range of about −600 to −400 [km] and the range of about 400 to 600 [km], it can be seen that the Doppler variation amount falls within the range of −15 to 15 [Hz/s].

That is, it can be seen that the terminal station 3 existing at points where the x-axis position of the mobile relay station 2 is within the range of about −600 to −400 [km] and within the range of about 400 to 600 [km] can demodulate and decode the activation signal.

In addition, in the case where the activation signal to which the frequency variation in the variation amount of 59 [Hz/s] is applied is used, as described above, it can be seen that the ranges on the ground where the x-axis position of the mobile relay station 2 is within the range of about −600 to −400 [km] and within the range of about 400 to 600 [km] are the activatable areas of the terminal station 3. Note that the graph illustrated in the lower part of FIG. 5 is the same as the graphs illustrated in the lower part of FIG. 2, the lower part of FIG. 3, and the lower part of FIG. 4, illustrates the relationship between the x-axis position of the mobile relay station 2 and the elevation angle.

Hereinafter, the activation signal to which the frequency variation of “the maximum Doppler variation amount−the Doppler shift tolerance” is applied is referred to as an “activation signal A”, the activation signal to which the frequency variation of “the maximum Doppler variation amount−the Doppler shift tolerance×3” is applied is referred to as an “activation signal B”, and the activation signal to which the frequency variation of “the maximum Doppler variation amount−the Doppler shift tolerance×5” is applied is referred to as an “activation signal C”.

As described above, the mobile relay station 2 performs time-division transmission of set switching and transmitting the activation signal A, the activation signal B, and the activation signal C at predetermined intervals, thereby setting a range of a combination of the activatable areas by the three activation signals as the activatable area of the terminal station 3. That is, the mobile relay station 2 can set the range on the ground where the x-axis position of the mobile relay station 2 is within the range of about−600 to 600 [km] as the activatable area of the terminal station 3.

In the above example, the activatable area of the terminal station 3 by the activation signal A, the activatable area of the terminal station 3 by the activation signal B, and the activatable area of the terminal station 3 by the activation signal C do not overlap with one another. However, the present embodiment is not limited to such a configuration, and a configuration in which the activatable areas of the terminal station 3 by the respective activation signals are set so as to slightly overlap with one another (to have a margin) may be employed.

For example, a value to be a predetermined margin may be determined, and the activation signal to which the frequency variation of “the maximum Doppler variation amount−the Doppler shift tolerance” is applied may be set as the activation signal A, the activation signal to which the frequency variation of “the maximum Doppler variation amount−the Doppler shift tolerance×3−the margin×1” is applied may be set as the activation signal B, and the activation signal to which the frequency variation of “the maximum Doppler variation amount−the Doppler shift tolerance×5−the margin×2” is applied may be set as the activation signal C. In addition, the number of types of activation signals to be used is not limited to three, and any number of activation signals may be used. With such a configuration, it is possible to prevent generation of a gap between the activatable areas at the timing when the activation signal is switched due to, for example, high-speed movement of the mobile relay station 2.

### Functional Configuration of Wireless Communication System

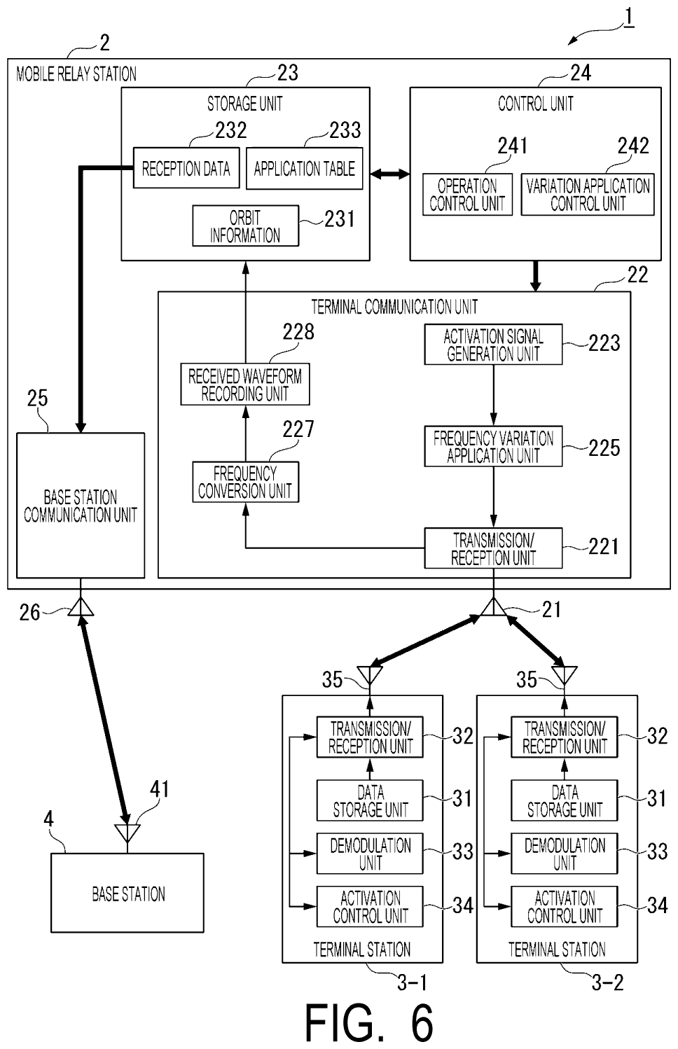

Hereinafter, a functional configuration of the wireless communication system 1 will be described. FIG. 6 is a block diagram illustrating a functional configuration of the wireless communication system 1 according to the first embodiment of the present invention. As illustrated in FIG. 6, the wireless communication system 1 includes the mobile relay station 2, the one or more terminal stations 3, and a base station 4.

The numbers of the mobile relay stations 2, the terminal stations 3, and the base stations 4 included in the wireless communication system 1 are arbitrary. It is assumed that the number of terminal stations 3 is large. FIG. 6 illustrates a case where the wireless communication system 1 includes two terminal stations 3-1 and 3-2. In the following description, when the terminal stations 3-1 and 3-2 are not particularly distinguished, they are simply referred to as terminal stations 3.

The mobile relay station 2 is an example of a wireless communication device that is mounted on a mobile object and of which an area where communication is possible moves over time. When having reached the sky above a data collection area, the mobile relay station 2 transmits an activation signal for activating the terminal station 3 on the ground. The mobile relay station 2 periodically transmits the activation signal, for example, at intervals of several seconds. The data collection area is an area for collecting data acquired by the terminal station 3. The mobile relay station 2 determines, for example, whether the mobile relay station 2 has reached the sky above the data collection area on the basis of orbit information of the mobile relay station 2 and time information.

The mobile relay station 2 of the present embodiment is provided in a low earth orbit (LEO) satellite. The altitude of the LEO satellite is 2000 [km] or less, and the LEO satellite orbits in the sky above the earth in about 1.5 hours per orbit. The terminal station 3 and the base station 4 are installed on the earth such as on the ground or on the sea. Hereinafter, a wireless signal transmitted from the terminal station 3 to the mobile relay station 2 will be referred to as a terminal uplink signal, and a signal transmitted from the mobile relay station 2 to the terminal station 3 and the base station 4 will be referred to as a downlink signal.

Since the mobile relay station 2 mounted on the LEO satellite performs communication while moving at a high speed, a time during which each terminal station 3 or the base station 4 can communicate with the mobile relay station 2 is limited. Specifically, seen from the ground, the mobile relay station 2 passes through the sky in about several minutes. Therefore, the terminal station 3 collects and stores data such as environmental data detected by the sensor. The terminal station 3 transmits the terminal uplink signal in which the collected data is set at timing at which communication with the mobile relay station 2 is possible.

The mobile relay station 2 receives the terminal uplink signal transmitted from each of the plurality of terminal stations 3 while moving in the sky above the earth. The mobile relay station 2 accumulates the data received from the terminal station 3 via the terminal uplink signal, and wirelessly transmits the accumulated data to the base station 4 via the downlink signal at timing at which the mobile relay station 2 can communicate with the base station 4. The base station 4 acquires the data collected by the terminal stations 3 from the received downlink signal.

The mobile relay station 2 includes an antenna used for wireless communication with the terminal station 3 and an antenna used for wireless communication with the base station 4. Therefore, the mobile relay station 2 can perform wireless communication with the terminal station 3 and wireless communication with the base station 4 in parallel.

As the mobile relay station 2, it is conceivable to use a relay station mounted on a geostationary satellite or an unmanned aerial vehicle such as a drone or a high altitude platform station (HAPS). However, in the case of a relay station mounted on a geostationary satellite, although a coverage area (footprint) on the ground is large, a link budget for an IoT terminal installed on the ground is very small due to high altitude. Meanwhile, the relay station mounted on a drone or a HAPS has a high link budget, but has a narrow coverage area. Furthermore, the drone requires a battery, and the HAPS requires a solar panel.

In the present embodiment, the mobile relay station 2 is mounted on the LEO satellite. Thus, the link budget falls within a limit, and, in addition, the LEO satellite has no air resistance and has low fuel consumption because the LEO satellite orbits outside the atmosphere. In addition, in a case where the mobile relay station 2 is mounted on the LEO satellite, the footprint is also larger than that in a case where the mobile relay station is mounted on the drone or the HAPS.

The terminal station 3 collects data such as environmental data detected by a sensor, for example. The terminal station 3 is activated on the basis of the activation signal transmitted from the mobile relay station 2, and wirelessly transmits the collected data to the mobile relay station 2. For example, in a case where transmission timing is instructed from the mobile relay station 2, the terminal station 3 wirelessly transmits the collected data to the mobile relay station 2 at the instructed transmission timing. The terminal station 3 is an aspect of a communication device.

The base station 4 receives the data collected by the terminal stations 3 from the mobile relay station 2.

The terminal station 3 and the base station 4 are installed at specific positions on the earth such as on the ground or on the sea.

Hereinafter, the configuration of each device will be described in more detail. First, a configuration of the mobile relay station 2 will be described. As illustrated in FIG. 6, the mobile relay station 2 includes one antenna 21, a terminal communication unit 22, a storage unit 23, a control unit 24, a base station communication unit 25, and one antenna 26. Note that the mobile relay station 2 may include a plurality of the antennas 21. In such a configuration, the mobile relay station 2 performs reception processing by multiple-input and multiple-output (MIMO).

The terminal communication unit 22 includes a transmission/reception unit 221, an activation signal generation unit 223, a frequency variation application unit 225, a frequency conversion unit 227, and a received waveform recording unit 228.

The transmission/reception unit 221 receives the terminal uplink signal through the antenna 21. In this manner, the transmission/reception unit 221 communicates with one or more terminal stations 3 via the antenna 21. The frequency conversion unit 227 converts a radio frequency (RF) signal, which is the terminal uplink signal received by the transmission/reception unit 221, into a baseband signal using a quadrature demodulator or the like. The frequency conversion unit 227 outputs the baseband signal to the received waveform recording unit 228.

The received waveform recording unit 228 acquires the baseband signal output from the frequency conversion unit 227. The received waveform recording unit 228 samples the baseband signal and records waveform data obtained by the sampling. The received waveform recording unit 228 stores the waveform data in the storage unit 23 as reception data 232.

The activation signal generation unit 223 generates the activation signal for activating the terminal station 3. Note that the activation signal may include information for identifying the specific terminal station 3, information indicating transmission timing of the terminal uplink signal, and the like.

The frequency variation application unit 225 applies the frequency variation to the activation signal generated by the activation signal generation unit 223 under control of a variation application control unit 242.

The storage unit 23 stores at least orbit information 231, reception data 232, and an application table 233. The orbit information 231 is information related to the orbit of the LEO satellite on which the mobile relay station 2 is mounted, and is, for example, information by which the position, speed, moving direction, and the like of the LEO satellite can be obtained at any time. The reception data 232 is data collected by the terminal station 3 and is data to be transmitted to the base station 4. The application table 233 is a table in which the value of the variation amount of the frequency variation to be applied to the activation signal by the frequency variation application unit 225 is registered for each of a plurality of types of activation signals.

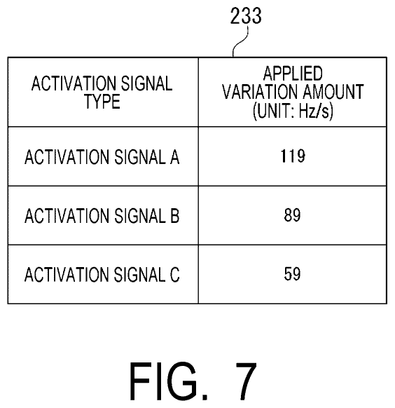

FIG. 7 is a table illustrating an example of the application table 233 according to the first embodiment of the present invention. The application table 233 has a plurality of records each indicating information of the variation amount of the frequency variation to be applied to the activation signal. The record has respective values of an activation signal type and an applied variation amount.

The values of the activation signal types represent identification information for identifying a plurality of types of activation signals sequentially switched and transmitted at predetermined intervals by the frequency variation application unit 225. The value of the applied variation amount is a value of the variation amount of the frequency variation, which is applied to each of the plurality of types of activation signals. For example, the unit of the value of the applied variation amount is Hz/s.

In the example illustrated in FIG. 7, for example, in the uppermost row of the application table 233, the activation signal type “activation signal A” and the applied variation amount “119” are associated with each other. This indicates that, in a period in which the activation signal A is transmitted, the frequency variation application unit 225 applies the frequency variation in the variation amount of 119 [Hz/s] to the activation signal generated by the activation signal generation unit 223.

The control unit 24 is configured using a processor such as a central processing unit (CPU) and a storage medium such as a memory. The control unit 24 implements the functions of an operation control unit 241 and the variation application control unit 242 by executing a program. Some or all of these functional units may be implemented by hardware (a circuit unit including circuitry) such as an application specific integrated circuit (ASIC), a programmable logic device (PLD), or a field programmable gate array (FPGA), or by cooperation of software and hardware. Some of these functions need not be mounted on the mobile relay station 2 in advance, and may be implemented by installing an additional application program in the mobile relay station 2.

The operation control unit 241 refers to the orbit information 231 and the time information, and determines whether the place where the LEO satellite equipped with the mobile relay station 2 is currently located is the sky above the data collection area. In the case of the data collection area, the operation control unit 241 instructs the variation application control unit 242 to acquire the value of the variation amount of the frequency variation and instructs the terminal communication unit 22 to transmit the activation signal. On the other hand, in the case of not the data collection area, the operation control unit 241 does nothing in particular.

In response to the instruction from the operation control unit 241, the variation application control unit 242 acquires information indicating the variation amount of the frequency variation to be applied to the activation signal from the application table 233 stored in the storage unit 23. The variation application control unit 242 controls the frequency variation application unit 225 such that the acquired variation amount of the frequency variation is applied to the activation signal. The variation application control unit 242 switches the variation amount of the frequency variation to be applied to the activation signal by the frequency variation application unit 225 at predetermined intervals.

The base station communication unit 25 reads the reception data 232 (waveform data) stored in the storage unit 23 from the storage unit 23 as transmission data to the base station 4. The base station communication unit 25 encodes and modulates the transmission data to generate the downlink signal. The base station communication unit 25 transmits the downlink signal through the antenna 26 at timing at which communication with the base station 4 is possible.

Note that, in the present embodiment, the variation application control unit 242 is configured to switch the variation amount of the frequency variation to be applied to the activation signal by the frequency variation application unit 225 at predetermined intervals but the embodiment is not limited to the configuration. For example, a configuration may be adopted in which the activation signal generated by the activation signal generation unit 223 is distributed to a plurality of frequency variation application units (not illustrated), the plurality of frequency variation application units applies the frequency variations in mutually different variation amounts to the activation signal, and the variation application control unit 242 switches one frequency variation application unit to be activated every predetermined period.

Next, a configuration of the terminal station 3 will be described. As illustrated in FIG. 6, the terminal station 3 includes a data storage unit 31, a transmission/reception unit 32, a demodulation unit 33, an activation control unit 34, and an antenna 35. To suppress power consumption, the terminal station 3 is in a sleep state except for some functions until receiving the activation signal from the mobile relay station 2. Here, the some functions are, for example, the data storage unit 31, the transmission/reception unit 32, the demodulation unit 33, and the activation control unit 34 illustrated in FIG. 6. The terminal station 3 may include a plurality of the antennas 35.

The data storage unit 31 stores the environmental data detected by a sensor. The transmission/reception unit 32 communicates with the mobile relay station 2. For example, the transmission/reception unit 32 receives the downlink signal transmitted from the mobile relay station 2. For example, the transmission/reception unit 32 reads the environmental data from the data storage unit 31 as the terminal transmission data. The transmission/reception unit 32 wirelessly transmits the terminal uplink signal in which the read terminal transmission data is set through the antenna 35.

The transmission/reception unit 32 transmits and receives signals by using low power wide area (LPWA), for example. LPWA includes LoRaWAN (registered trademark), Sigfox (registered trademark), Long Term Evolution for Machines (LTE-M), Narrow Band (NB)-IoT, and the like, but any wireless communication scheme can be used. The transmission/reception unit 32 may perform transmission and reception with another terminal station 3 by using time division multiplexing, orthogonal frequency division multiplexing (OFDM), or the like. The transmission/reception unit 32 may perform beam formation of signals to be transmitted through the plurality of antennas 35 by a method determined in advance in the wireless communication scheme to be used.

The demodulation unit 33 demodulates and decodes the downlink signal received by the transmission/reception unit 32. A Doppler variation occurs in the downlink signal according to the distance between the mobile relay station 2 and the terminal station 3.

The activation control unit 34 performs control to shift the terminal station 3 from the sleep state to the activated state according to the activation signal included in the downlink signal demodulated and decoded by the demodulation unit 33.

Next, a configuration of the base station 4 will be described. As illustrated in FIG. 6, the base station 4 includes an antenna 41. The base station 4 converts the downlink signal received by the antenna 41 into an electrical signal, and then performs demodulation and decoding to obtain waveform data. The base station 4 performs reception processing for the terminal uplink signal included in the waveform data. At this time, the base station 4 acquires terminal transmission data by performing the reception processing according to the wireless communication scheme used for transmission by the terminal station 3.

Note that, as described above, in the present embodiment, the mobile relay station 2 is configured to perform frequency conversion of an RF signal that is the terminal uplink signal into the baseband signal, record the waveform data obtained by sampling the baseband signal, and transmit the waveform data to the base station 4. Therefore, in the present embodiment, the mobile relay station 2 is configured not to perform the reception processing for obtaining the terminal transmission data.

However, the present embodiment is not limited to such a configuration, and for example, the mobile relay station 2 may transmit, to the base station 4, waveform data obtained by sampling the terminal uplink signal as an RF signal. Then, the base station 4 may be configured to perform the reception processing after converting the frequency of the RF signal indicating the waveform data into the baseband signal.

Alternatively, for example, the mobile relay station 2 may convert the frequency of the RF signal that is the terminal uplink signal into the baseband signal, and perform the reception processing up to demodulation and decoding of the terminal uplink signal. Then, the mobile relay station 2 may transmit the terminal transmission data obtained by the reception processing to the base station 4.

### Operation of Mobile Relay Station

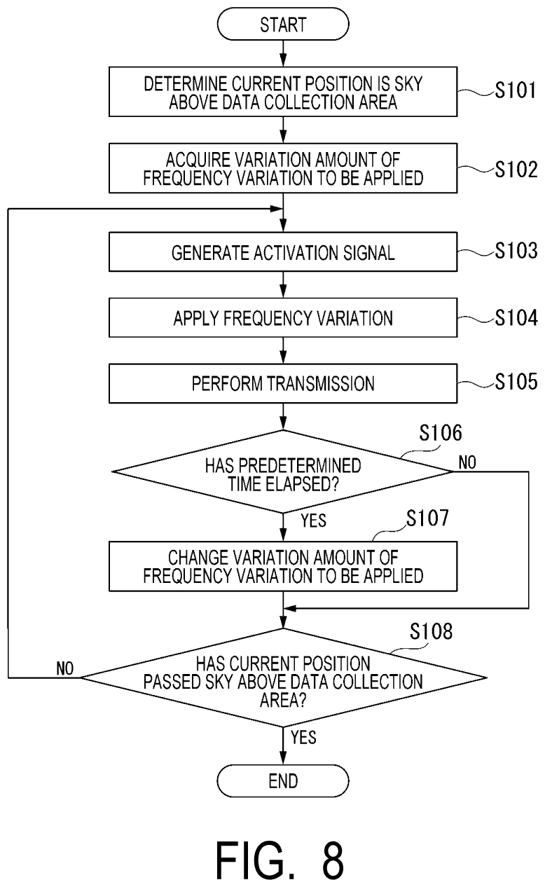

Hereinafter, an example of the operation of the mobile relay station 2 will be described. FIG. 8 is a flowchart illustrating a flow of activation processing for the terminal station 3 performed by the mobile relay station 2 according to the first embodiment of the present invention.

The operation control unit 241 determines that the current position of the mobile relay station 2 is the sky above the data collection area (step S101). The operation control unit 241 instructs the variation application control unit 242 to acquire the value of the variation amount of the frequency variation and instructs the terminal communication unit 22 to transmit the activation signal. In response to the instruction from the operation control unit 241, the variation application control unit 242 refers to the application table 233 and acquires the value of the variation amount of the frequency variation for each type of the activation signals (for example, the activation signal A, the activation signal B, and the activation signal C described above) (step S102).

The activation signal generation unit 223 generates the activation signal in response to the instruction from the operation control unit 241 (step S103). The activation signal generation unit 223 outputs the generated activation signal to the frequency variation application unit 225. The variation application control unit 242 controls the frequency variation application unit 225 to apply the variation amount of the frequency variation acquired from the application table 233 to the activation signal. The frequency variation application unit 225 applies the frequency variation to the activation signal generated by the activation signal generation unit 223 under the control of the variation application control unit 242 (step S104).

The frequency variation application unit 225 outputs the activation signal to which the frequency variation is applied to the transmission/reception unit 221. The transmission/reception unit 221 transmits the activation signal output from the frequency variation application unit 225 to the ground via the antenna 21 as the downlink signal (step S105).

In a case where a predetermined time has elapsed (step S106: YES), the variation application control unit 242 controls the frequency variation application unit 225 to change the variation amount of the frequency variation to be applied to the activation signal (step S107).

In a case of determining that the current position of the mobile relay station 2 has passed the sky above the data collection area (step S108: YES), the operation control unit 241 terminates the processing of activating the terminal station 3 performed by the mobile relay station 2. That is, while being in the sky above the data collection area, the mobile relay station 2 repeatedly executes the processing from step S103 to step S108.

### Operation of Terminal Station

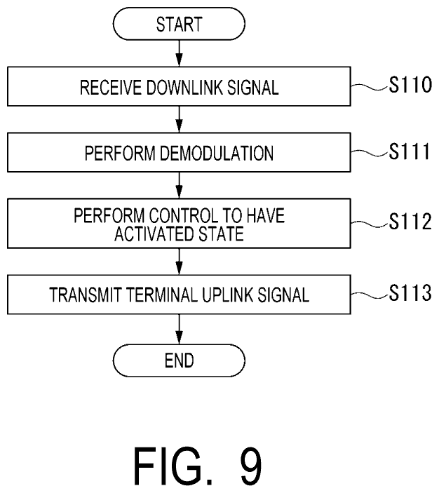

Hereinafter, an example of the operation of the terminal station 3 will be described. FIG. 9 is a flowchart illustrating a flow of activation processing for the terminal station 3 according to the first embodiment of the present invention.

The downlink signal transmitted from the mobile relay station 2 in step S105 of the flowchart of FIG. 8 is received by the terminal station 3 located in a range where a radio wave transmitted from the mobile relay station 2 reaches. The transmission/reception unit 32 of the terminal station 3 receives the downlink signal transmitted from the mobile relay station 2 (step S110).

The transmission/reception unit 32 of the terminal station 3 outputs the received downlink signal to the demodulation unit 33. The demodulation unit 33 of the terminal station 3 demodulates and decodes the downlink signal (step S111). The activation control unit 34 of the terminal station 3 performs control to shift the terminal station 3 from the sleep state to the activated state on the basis of the activation signal demodulated and decoded by the demodulation unit 33 (step S112).

The transmission/reception unit 32 of the terminal station 3 transmits the terminal uplink signal based on the environmental data stored in the data storage unit 31 to the mobile relay station 2 (step S113). As a result, the mobile relay station 2 can receive the terminal uplink signal transmitted from each terminal station 3.

According to the wireless communication system 1 in the first embodiment configured as described above, the mobile relay station 2 applies the frequency variation that cancels (compensates for) the Doppler variation to the activation signal in advance, and transmits the activation signal to which the frequency variation is applied to the ground. As a result, even if the Doppler variation occurs in the activation signal received by the terminal station 3 installed on the ground, the Doppler variation is canceled by the frequency variation applied in advance to the activation signal, so that the terminal station 3 can demodulate the activation signal. As described above, in the wireless communication system 1, even in the case where Doppler variation occurs in the activation signal transmitted from the mobile relay station 2 moving in the sky, it is possible to activate the terminal station 3 installed on the ground.

Furthermore, in the wireless communication system 1 according to the first embodiment, since the mobile relay station 2 sequentially transmits the plurality of types of activation signals to which the frequency variations in different variation amounts are applied to the ground while switching the activation signals at predetermined intervals, it is possible to cancel (compensate for) Doppler variations of a wider variation amount, and thus it is possible to secure a wider activatable area of the terminal station 3.

In the first embodiment, the configuration has been described in which the mobile relay station 2 determines whether the mobile relay station 2 is in the sky above the data collection area on the basis of the orbit information 231 and the time information. However, the embodiment is not limited to such a configuration, and the mobile relay station 2 may be configured to determine whether the mobile relay station 2 is in the sky above the data collection area by another method. Specifically, for example, the mobile relay station 2 may grasp a start time and an end time at which data is collected from the terminal station 3 by uplink communication from the base station 4, and determine to be being in the sky above the data collection area from the start time to the end time.

Note that, in the first embodiment, the case has been described in which the mobile object equipped with the mobile relay station 2 is an LEO satellite. However, the mobile object may be another flying object flying in the sky, such as a geostationary satellite, a drone, or a HAPS.

### Modification of First Embodiment

Hereinafter, a modification of the first embodiment will be described. In the above-described first embodiment, the mobile relay station 2 is configured to perform time-division transmission of transmitting while sequentially switching the activation signal A, the activation signal B, and the activation signal C at predetermined intervals. In this case, as will be described below, the activatable area of the terminal station 3 by the activation signal A and the activatable area of the terminal station 3 by the activation signal B are adjacent to each other, and the activatable area of the terminal station 3 by the activation signal B and the activatable area of the terminal station 3 by the activation signal C are adjacent to each other.

As illustrated in the upper graph of FIG. 3, the activatable area of the terminal station 3 by the activation signal A is the range on the ground where the x-axis position of the mobile relay station 2 is within the range of about −200 to 200 [km]. In addition, as illustrated in the upper graph of FIG. 4, the activatable area of the terminal station 3 by the activation signal B is the range on the ground where the x-axis position of the mobile relay station 2 is within the range of about −400 to −200 [km] and within the range of about 200 to 400 [km]. In addition, as illustrated in the upper graph of FIG. 5, the activatable area of the terminal station 3 by the activation signal C is the range on the ground where the x-axis position of the mobile relay station 2 is within the range of about −600 to −400 [km] and within the range of about 400 to 600 [km].

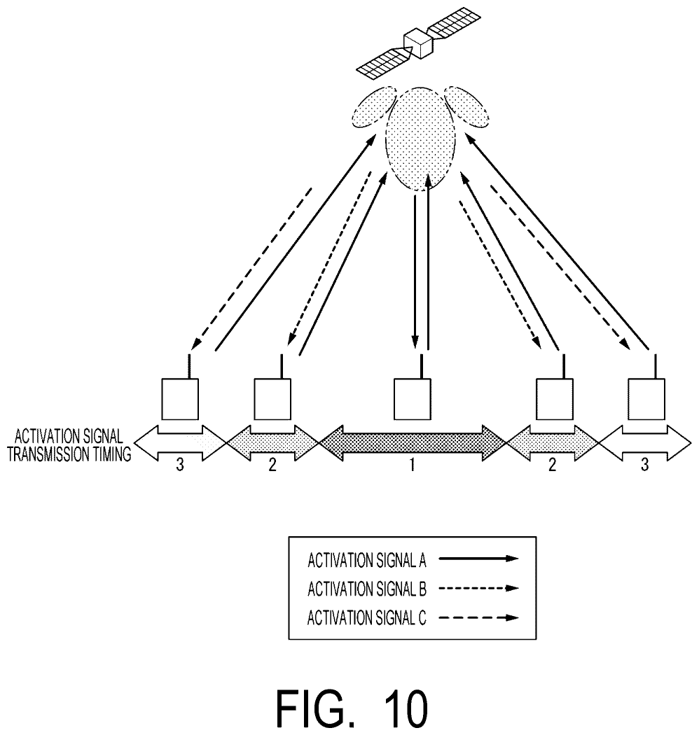

FIG. 10 is a schematic diagram for describing a relationship between the transmission timing of the activation signal and the activatable area by the wireless communication system 1 according to the above-described first embodiment of the present invention. As illustrated in FIG. 10, according to the above-described wireless communication system 1 of the first embodiment, every time the variation amount of the frequency variation applied to the activation signal is switched at predetermined intervals, the activatable area is shifted such that the adjacent areas on the ground sequentially become the activatable area of the terminal station 3.

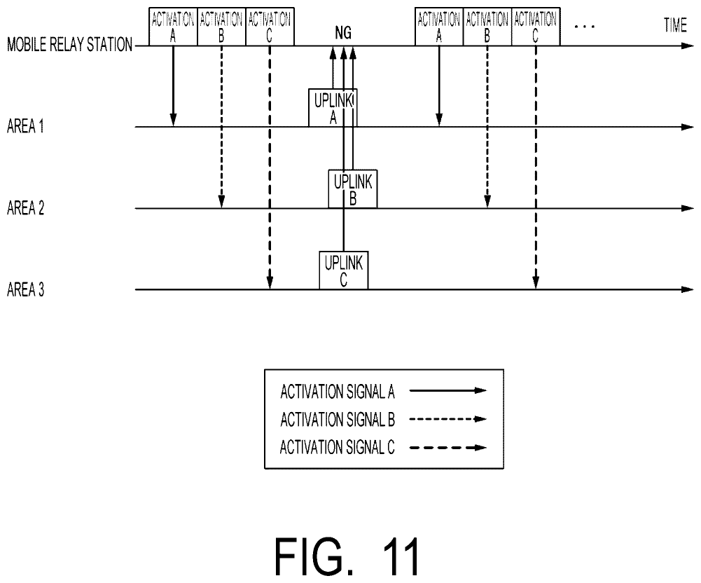

However, in this case, it is conceivable that an opportunity for the plurality of terminal stations 3 in the adjacent areas to transmit the terminal uplink signal to the mobile relay station 2 at the same timing increases. FIG. 11 is a schematic diagram for describing a relationship between the transmission timing of the activation signal and transmission timing of a terminal uplink signal by the wireless communication system 1 according to the above-described first embodiment of the present invention. In FIG. 11, the horizontal axis represents a time. As illustrated in FIG. 11, the mobile relay station 2 in the first embodiment transmits the activation signal toward the ground while switching the activation signal A (“activation A” in FIG. 11), the activation signal B (“activation B” in FIG. 11), and the activation signal C (“activation C” in FIG. 11) in this order at predetermined intervals.

In this case, for example, there is a possibility that the terminal uplink signal (“uplink A” in FIG. 11) transmitted from the terminal station 3 activated by the activation signal A, the terminal uplink signal (“uplink B” in FIG. 11) transmitted from the terminal station 3 activated by the activation signal B, and the terminal uplink signal (“uplink C” in FIG. 11) transmitted from the terminal station 3 activated by the activation signal C are transmitted at the same timing. In this way, when the terminal uplink signals are transmitted at the same timing from the plurality of terminal stations 3 existing in the areas adjacent to each other, there is a higher possibility that the terminal uplink signals collide with each other and the mobile relay station 2 cannot perform signal separation.

In contrast, the mobile relay station 2 in the modification of the first embodiment to be described below controls the transmission timing and the transmission order of each activation signal so that the terminal uplink signals are not transmitted at the same timing from the plurality of terminal stations 3 existing in the areas adjacent to each other.

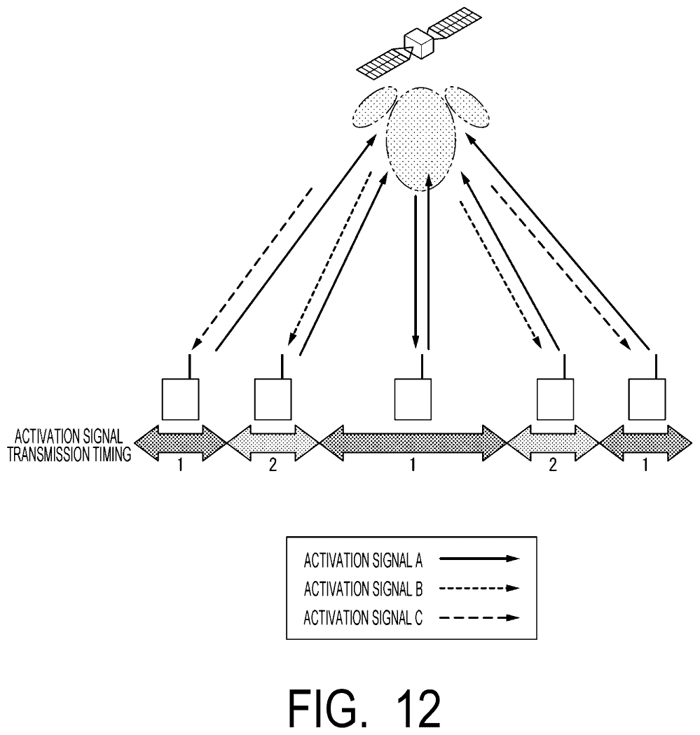

FIG. 12 is a schematic diagram for describing a relationship between the transmission timing of the activation signal and the activatable area by the wireless communication system 1 according to a modification of the first embodiment of the present invention. The wireless communication system 1 according to the modification of the first embodiment performs control so that the activatable area after switching is not adjacent to the activatable area before switching in a case of switching the variation amount of the frequency variation applied to the activation signal predetermined intervals. For example, as illustrated in FIG. 12, the wireless communication system 1 according to the modification of the first embodiment performs control so that the timing at which the activation signal A and the activation signal C are transmitted and the timing at which the activation signal B is transmitted are not close to each other.

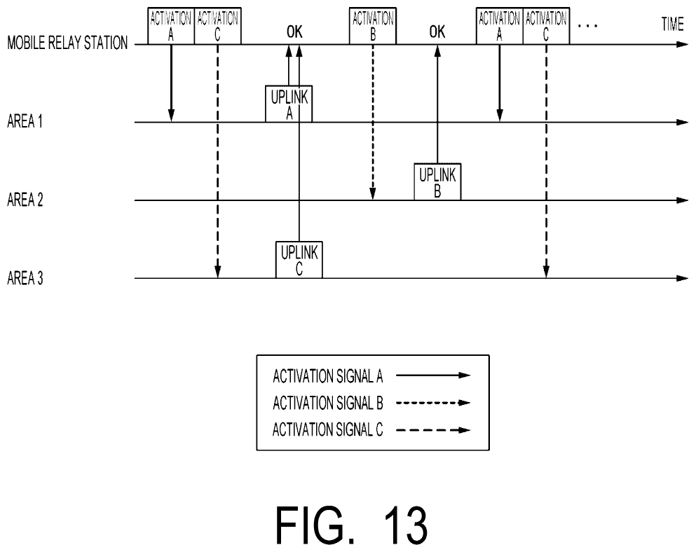

FIG. 13 is a schematic diagram for describing a relationship between the transmission timing of the activation signal and the transmission timing of the terminal uplink signal by the wireless communication system 1 according to the modification of the first embodiment of the present invention. In FIG. 13, the horizontal axis represents a time. As illustrated in FIG. 13, the mobile relay station 2 according to the modification of the first embodiment transmits the activation signal A (“activation A” in FIG. 13) to the ground, then followed by the activation signal C (“activation C” in FIG. 13) to the ground after a predetermined period.

In this case, for example, there is a possibility that the terminal uplink signal (“uplink A” in FIG. 13) transmitted from the terminal station 3 activated by the activation signal A and the terminal uplink signal (“uplink C” in FIG. 13) transmitted from the terminal station 3 activated by the activation signal C are transmitted at the same timing. As described above, there is a possibility that the terminal uplink signals collide with each other when the terminal uplink signals are transmitted from the plurality of terminal stations 3 at the same timing.

However, as described above, the activatable area by the activation signal A and the activatable area by the activation signal C are not adjacent to each other. Even if a collision occurs between the terminal uplink signals transmitted at the same timing from the plurality of terminal stations 3 existing in the areas not adjacent to each other in this manner, signal separation is easily performed by reception beam control. Therefore, the mobile relay station 2 can demodulate and decode both the terminal uplink signal (“uplink A” in FIG. 13) transmitted from the terminal station 3 activated by the activation signal A and the terminal uplink signal (“uplink C” in FIG. 13) transmitted from the terminal station 3 activated by the activation signal C.

Then, the mobile relay station 2 transmits another activation signal that has the activatable area adjacent to the activatable area by the previously transmitted activation signal with a short interval. For example, as illustrated in FIG. 13, the mobile relay station 2 transmits the activation signal A and the activation signal C to the ground, and then transmits the activation signal B to the ground at a short interval. Specifically, for example, the mobile relay station 2 transmits the activation signal A and the activation signal C within a same downlink transmission period, and transmits the activation signal B in a downlink transmission period different from the above-described downlink transmission period.

According to the wireless communication system 1 in the modification of the first embodiment configured as described above, the mobile relay station 2 applies the frequency variation that cancels (compensates for) the Doppler variation to the activation signal in advance, and transmits the activation signal to which the frequency variation is applied to the ground. As a result, even if the Doppler variation occurs in the activation signal received by the terminal station 3 installed on the ground, the Doppler variation is canceled by the frequency variation applied in advance to the activation signal, so that the terminal station 3 can demodulate and decode the activation signal. As described above, in the wireless communication system 1, even in the case where Doppler variation occurs in the activation signal transmitted from the mobile relay station 2 moving in the sky, it is possible to activate the terminal station 3 installed on the ground.

Furthermore, in the wireless communication system 1 according to the modification of the first embodiment, the transmission timing of each activation signal is controlled so that the terminal uplink signals are not transmitted at the same timing from the plurality of terminal stations 3 existing in the areas adjacent to each other. With such a configuration, the wireless communication system 1 can suppress that the terminal uplink signals cannot be demodulated and decoded due to a collision of the plurality of terminal uplink signals. Note that, as described above, even if the terminal uplink signals transmitted at the same timing from the plurality of terminal stations 3 existing in the areas not adjacent to each other cause a collision, the mobile relay station 2 can perform signal separation by reception beam control, and thus can demodulate and decode each terminal uplink signal.

### Second Embodiment

Hereinafter, a second embodiment will be described. The above-described first embodiment is an embodiment mainly assuming a case where a signal bandwidth of the activation signal is a relatively wide band, for example, several tens of kHz. In this case, an influence of the Doppler shift of the activation signal can be compensated by a frequency offset compensation function generally provided on the terminal station 3 side. Therefore, in the above-described first embodiment, only the influence of the Doppler variation is a problem, and the influence of the Doppler shift is not considered.

However, as the signal bandwidth of the activation signal becomes narrower, the range of the Doppler shift that can be compensated becomes narrower, and the influence of the Doppler shift of the KHz order caused by high-speed movement of a low earth orbit satellite cannot be compensated only by the frequency offset compensation function generally provided on the terminal station 3 side. Therefore, a wireless communication system 1a in the second embodiment to be described below not only compensates for an influence of a Doppler variation but also compensates for an influence of a Doppler shift. That is, a mobile relay station 2a in the second embodiment applies a frequency shift for canceling an assumed Doppler shift to an activation signal in advance, and then transmits the activation signal to a terminal station 3.

In addition, according to the above-described wireless communication system 1 in the first embodiment, the activatable area is formed in the range on the ground ahead of the mobile relay station 2 and in the range on the ground behind the mobile relay station 2, for example, as illustrated in FIGS. 1, 4, and 5, depending on the variation amount of the frequency variation applied to the activation signal.

For example, as illustrated in FIG. 4, under the condition of the first embodiment, in the case where the mobile relay station 2 applies the frequency variation in the variation amount of “the maximum Doppler variation amount−the Doppler shift tolerance×3” to the activation signal, the activatable area is formed in the range of 200 to 400 [km] ahead of the mobile relay station 2 and in the range of 200 to 400 [km] behind the mobile relay station 2. Further, for example, as illustrated in FIG. 5, under the condition of the first embodiment, in the case where the mobile relay station 2 applies the frequency variation in the variation amount of “the maximum Doppler variation amount−the Doppler shift tolerance×5” to the activation signal, the activatable area is formed in the range of 400 to 600 [km] ahead of the mobile relay station 2 and in the range of 400 to 600 [km] behind the mobile relay station 2.

However, the area ahead of the mobile relay station 2 is generally an area to which the mobile relay station 2 is about to go, and is an area where data is desired to be actively collected from the terminal station 3 existing in the area. On the other hand, the area behind the mobile relay station 2 is generally an area in which the mobile relay station 2 moves away with time and a communication success rate of communication between the terminal station 3 and the mobile relay station 2 existing in the area gradually decreases, and thus is not an area in which data is desired to be actively collected from the terminal station 3 existing in the area. For such an area on the ground behind the mobile relay station 2, a higher communication success rate can be expected when the data collection from the terminal station 3 existing in the area is entrusted to another mobile relay station 2 that arrives later.

Note that the wireless communication system 1a in the second embodiment to be described below has the configuration of not only compensating for the influence of the Doppler variation but also compensating for the influence of the Doppler shift, as described above. As a result, the wireless communication system 1a can also perform activation control of the terminal station 3, for example, activating only the terminal station 3 existing in the area ahead of the mobile relay station 2a in the second embodiment.

Specifically, in the terminal station 3 existing in the area ahead of the mobile relay station 2a, a reception frequency of the activation signal is shifted in a higher direction due to the influence of the Doppler shift. To compensate for the influence of such a Doppler shift, the mobile relay station 2a shifts a transmission frequency of the activation signal in a lower direction in advance. Note that, at this time, the mobile relay station 2a also applies a frequency variation to the activation signal to compensate for the influence of the Doppler variation performed by the mobile relay station 2 in the above-described first embodiment.

Further, in the terminal station 3 existing in the area behind the mobile relay station 2a in the second embodiment, the reception frequency of the activation signal is shifted in a lower direction due to the influence of the Doppler shift. Then, if the mobile relay station 2a does not apply a frequency shift for canceling the Doppler shift to the activation signal at this time, the terminal station 3 side existing in the area behind the mobile relay station 2a cannot compensate for the influence of the Doppler shift.

With such a configuration, the wireless communication system 1a according to the second embodiment can activate only the terminal station 3 existing in the area on the ground ahead of the mobile relay station 2a. On the contrary, the wireless communication system 1a in the second embodiment can be configured to activate only the terminal station 3 existing in the area behind the mobile relay station 2a.

### Configuration of Wireless Communication System

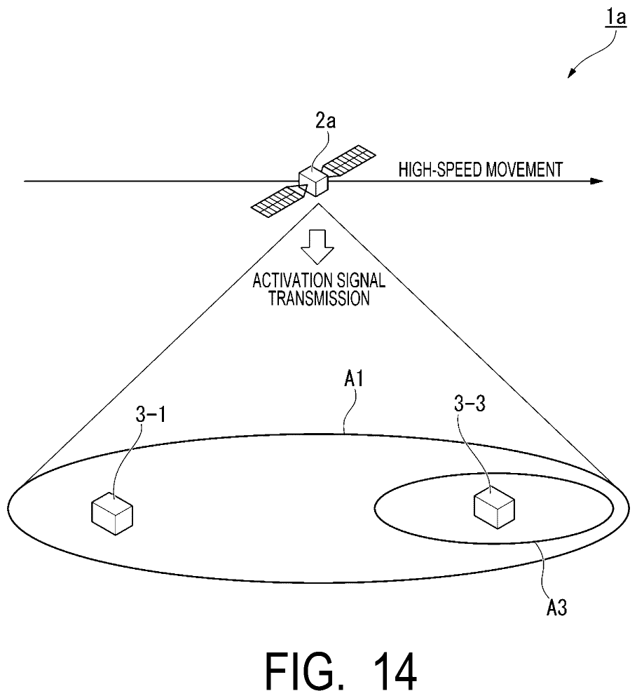

Hereinafter, the configuration of the wireless communication system 1a according to the second embodiment will be described in more detail. FIG. 14 is a schematic diagram for describing a configuration of a wireless communication system la according to a second embodiment of the present invention.

As illustrated in FIG. 14, the wireless communication system 1a in the second embodiment includes at least a mobile relay station 2a and one or more terminal stations 3. FIG. 14 illustrates a case where there are two terminal stations 3-1 and 3-3 as an example.

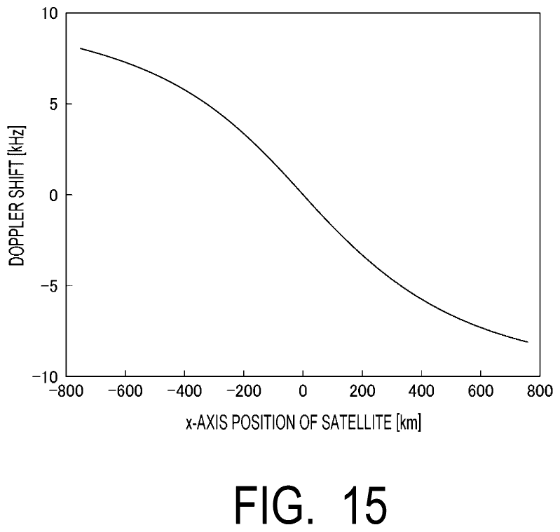

Since the mobile relay station 2a moves at a high speed, a Doppler shift of the KHz order occurs when the activation signal transmitted by the mobile relay station 2a is received by the terminal station 3 disposed in each area. FIG. 15 is a graph illustrating an example of a relationship between the position of the mobile relay station 2a with respect to the terminal station 3 and the Doppler shift. When the Doppler shift occurs in the activation signal, the terminal station 3 may not be able to demodulate and decode the activation signal.

Therefore, when transmitting the activation signal, the mobile relay station 2a in the second embodiment transmits the activation signal to which the frequency shift is applied.

It is assumed that a shift amount of the frequency shift is determined in advance on the basis of an altitude of the mobile relay station 2a (more specifically, a moving speed of the mobile relay station 2a determined by the altitude), a downlink transmission frequency, and positions of the mobile relay station 2a and the area. For example, in a case where it is desired to activate the terminal station 3 in the area near 300 [km] from directly below the mobile relay station 2a toward the front of the mobile relay station 2a, the mobile relay station 2a can cancel the influence of the Doppler shift by applying the frequency shift of the shift amount of about −5 [KHz] to the activation signal, and the terminal station 3 can demodulate and decode the activation signal.

### Functional Configuration of Wireless Communication System

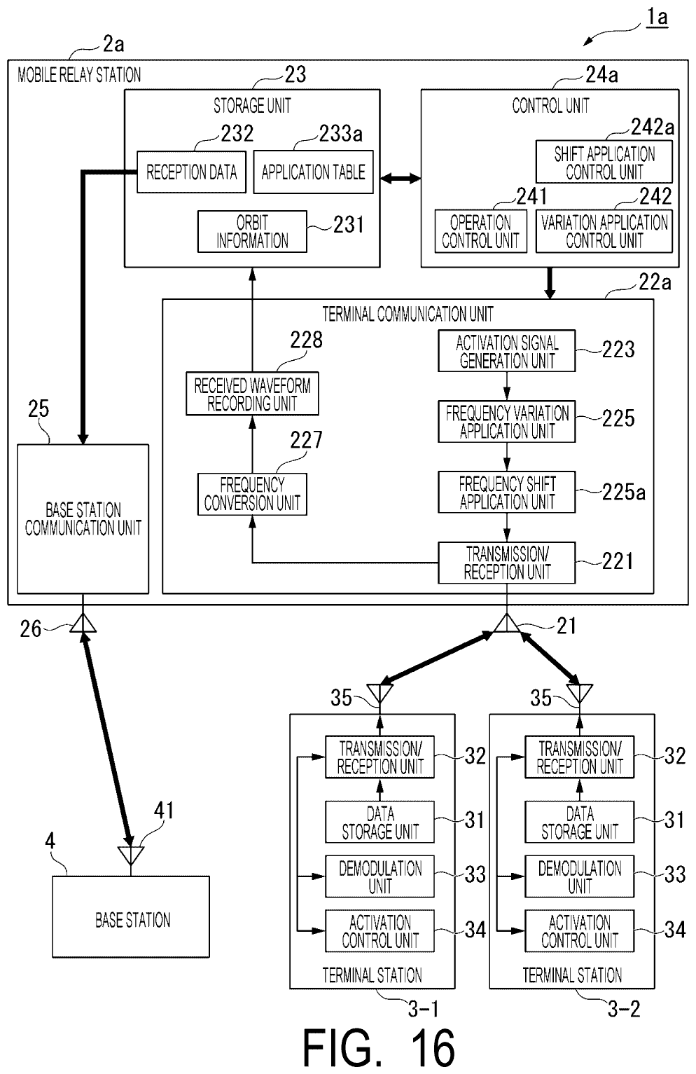

Hereinafter, a functional configuration of the wireless communication system la will be described. FIG. 16 is a block diagram illustrating a functional configuration of the wireless communication system 1a according to the second embodiment of the present invention. Note that, in the functional configuration of the wireless communication system 1a, functional units having similar configurations to the functional units included in the wireless communication system 1 in the above-described first embodiment illustrated in FIG. 6 are denoted by the same reference numerals, and description thereof may be omitted.

The wireless communication system 1 in the first embodiment illustrated in FIG. 6 includes the mobile relay station 2, whereas the wireless communication system la in the second embodiment illustrated in FIG. 16 includes the mobile relay station 2a instead of the mobile relay station 2. In addition, the mobile relay station 2 in the first embodiment illustrated in FIG. 6 includes the terminal communication unit 22 and the control unit 24, whereas the mobile relay station 2a in the second embodiment illustrated in FIG. 16 includes a terminal communication unit 22a and a control unit 24a instead of the terminal communication unit 22 and the control unit 24.

The terminal communication unit 22a in the second embodiment illustrated in FIG. 16 further includes a frequency shift application unit 225a in addition to the functional configuration of the terminal communication unit 22 in the above-described first embodiment illustrated in FIG. 6. Furthermore, the control unit 24a in the second embodiment illustrated in FIG. 16 further includes a shift application control unit 242a in addition to the functional configuration of the control unit 24 in the above-described first embodiment illustrated in FIG. 6.

Hereinafter, a configuration of the mobile relay station 2a will be described. As illustrated in FIG. 16, the mobile relay station 2a includes one antenna 21, the terminal communication unit 22a, a storage unit 23, the control unit 24a, a base station communication unit 25, and one antenna 26. Note that the mobile relay station 2a may include a plurality of the antennas 21. In such a configuration, the mobile relay station 2a performs reception processing by MIMO.

The terminal communication unit 22a includes a transmission/reception unit 221, an activation signal generation unit 223, a frequency variation application unit 225, a frequency shift application unit 225a, a frequency conversion unit 227, and a received waveform recording unit 228.

The transmission/reception unit 221 receives a terminal uplink signal through the antenna 21. In this manner, the transmission/reception unit 221 communicates with one or more terminal stations 3 via the antenna 21.

The frequency conversion unit 227 converts an RF signal, which is the terminal uplink signal received by the transmission/reception unit 221, into a baseband signal using a quadrature demodulator or the like. The frequency conversion unit 227 outputs the baseband signal to the received waveform recording unit 228. The received waveform recording unit 228 acquires the baseband signal output from the frequency conversion unit 227. The received waveform recording unit 228 samples the baseband signal and records waveform data obtained by the sampling. The received waveform recording unit 228 stores the waveform data in the storage unit 23 as reception data 232.

The activation signal generation unit 223 generates the activation signal for activating the terminal station 3.

The frequency variation application unit 225 applies the frequency variation to the activation signal generated by the activation signal generation unit 223 under control of a variation application control unit 242.

The frequency shift application unit 225a applies the frequency shift to the activation signal to which the frequency variation is applied by the frequency variation application unit 225 under the control of the shift application control unit 242a.

The storage unit 23 stores at least orbit information 231, reception data 232, and an application table 233a. The orbit information 231 is information related to an orbit of an LEO satellite on which the mobile relay station 2 is mounted, and is, for example, information by which position, speed, moving direction, and the like of the LEO satellite can be obtained at any time. The reception data 232 is data collected by the terminal station 3 and is data to be transmitted to the base station 4. The application table 233a is a table in which a value of the variation amount of the frequency variation applied to the activation signal by the frequency variation application unit 225 and a value of the shift amount of the frequency shift applied to the activation signal by the frequency shift application unit 225a are registered for each activation signal.

The value of the shift amount of the frequency shift included in the application table 233a is determined in advance on the basis of the altitude of the mobile relay station 2a (more specifically, the moving speed of the mobile relay station 2a determined by the altitude), the downlink transmission frequency, and the positions of the mobile relay station 2a and the area.

The control unit 24a includes a processor such as a CPU and a memory. The control unit 24a implements the functions of the operation control unit 241, the variation application control unit 242, and the shift application control unit 242a by executing a program. Some or all of these functional units may be implemented by hardware such as ASIC, PLD, or FPGA, or by cooperation of software and hardware. Some of these functions need not be mounted in the mobile relay station 2a in advance, and may be implemented by installing an additional application program in the mobile relay station 2a.

The operation control unit 241 refers to the orbit information 231 and time information, and determines whether a place where the LEO satellite equipped with the mobile relay station 2a is currently located is the sky above a data collection area. In the case of the data collection area, the operation control unit 241 instructs the variation application control unit 242 to acquire the value of the variation amount of the frequency variation, instructs the shift application control unit 242a to acquire the value of the shift amount of the frequency shift, and instructs the terminal communication unit 22a to transmit the activation signal. On the other hand, in the case of not the data collection area, the operation control unit 241 does nothing in particular.

In response to the instruction from the operation control unit 241, the variation application control unit 242 acquires the value of the variation amount of the frequency variation to be applied to the activation signal from the application table 233a stored in the storage unit 23. The variation application control unit 242 controls the frequency variation application unit 225 such that the acquired variation amount of the frequency variation is applied to the activation signal. The variation application control unit 242 switches the variation amount of the frequency variation to be applied to the activation signal by the frequency variation application unit 225 at predetermined intervals.

In response to the instruction from the operation control unit 241, the shift application control unit 242a acquires the value of the shift amount of the frequency shift to be applied to the activation signal from the application table 233a stored in the storage unit 23. The shift application control unit 242a controls the frequency shift application unit 225a such that the acquired shift amount of the frequency shift is applied to the activation signal. The shift application control unit 242a switches the shift amount of the frequency shift to be applied to the activation signal by the frequency shift application unit 225a at predetermined intervals.

### Operation of Mobile Relay Station

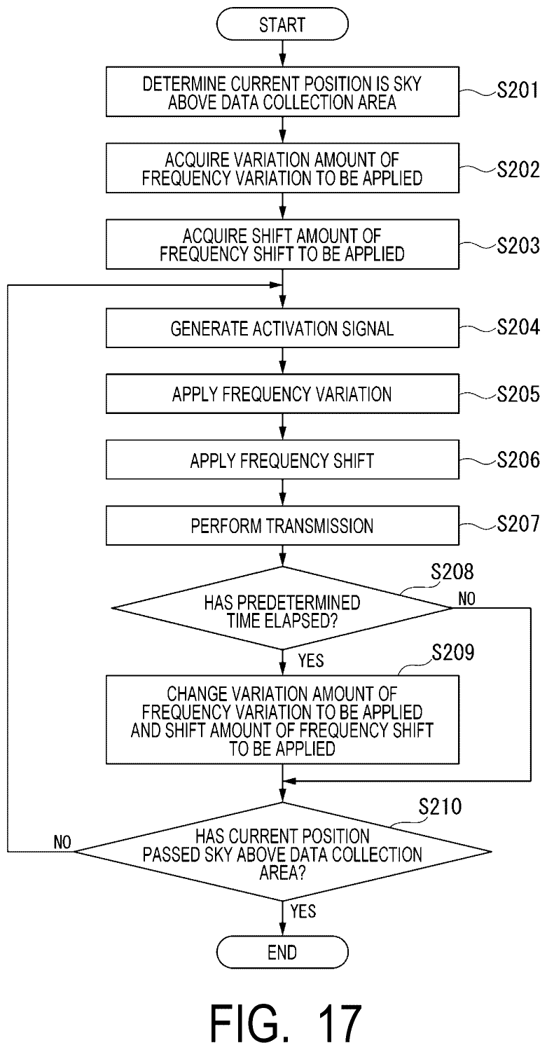

Hereinafter, an example of the operation of the mobile relay station 2a will be described. FIG. 17 is a flowchart illustrating a flow of activation processing for the terminal station 3 performed by the mobile relay station 2a according to the second embodiment of the present invention.

The operation control unit 241 determines that the current position of the mobile relay station 2a is the sky above the data collection area (step S201). The operation control unit 241 instructs the variation application control unit 242 to acquire the value of the variation amount of the frequency variation, instructs the shift application control unit 242a to acquire the value of the shift amount of the frequency shift, and instructs the terminal communication unit 22a to transmit the activation signal.

In response to the instruction from the operation control unit 241, the variation application control unit 242 refers to the application table 233a and acquires the value of the variation amount of the frequency variation for each type of the activation signals (for example, an activation signal A, an activation signal B, and an activation signal C) (step S202). In response to the instruction from the operation control unit 241, the shift application control unit 242a refers to the application table 233a and acquires the value of the shift amount of the predetermined frequency shift to be applied to the activation signal (step S203).

The activation signal generation unit 223 generates the activation signal in response to an instruction from the operation control unit 241 (step S204). The activation signal generation unit 223 outputs the generated activation signal to the frequency variation application unit 225.

The variation application control unit 242 controls the frequency variation application unit 225 so that the frequency variation of the variation amount acquired from the application table 233 is applied to the activation signal. The frequency variation application unit 225 applies the frequency variation to the activation signal generated by the activation signal generation unit 223 under the control of the variation application control unit 242 (step S205).

The shift application control unit 242a controls the frequency shift application unit 225a so that the frequency shift of the shift amount acquired from the storage unit 23 is applied to the activation signal. The frequency shift application unit 225a further applies the frequency shift to the activation signal to which the frequency variation is applied by the frequency variation application unit 225 under the control of the shift application control unit 242a (step S206).

The frequency shift application unit 225a outputs the activation signal to which the frequency shift is applied to the transmission/reception unit 221. The transmission/reception unit 221 transmits the activation signal output from the frequency shift application unit 225a to the ground via the antenna 21 as the downlink signal (step S207).

In a case where a predetermined time has elapsed (step S208: YES), the variation application control unit 242 changes the variation amount of the frequency variation to be applied to the activation signal by the frequency variation application unit 225, and the shift application control unit 242a changes the shift amount of the frequency shift to be applied to the activation signal by the frequency shift application unit 225a (step S209).

In a case of determining that the current position of the mobile relay station 2a has passed the sky above the data collection area (step S210: YES), the operation control unit 241 terminates the processing of activating the terminal station 3 performed by the mobile relay station 2a. That is, while being in the sky above the data collection area, the mobile relay station 2a repeatedly executes the processing from step S204 to step S210.

Since the operation of the terminal station 3 in the second embodiment is similar to the operation of the terminal station 3 in the first embodiment illustrated in FIG. 9, the description thereof will be omitted.

According to the wireless communication system 1a in the second embodiment configured as described above, the mobile relay station 2a applies the frequency shift for canceling (compensating for) the Doppler shift to the activation signal in advance, and transmits the activation signal to which the frequency shift is applied. As a result, even if the Doppler shift occurs in the activation signal received by the terminal station 3 installed on the ground, since the frequency shift of the shift amount suitable for the area is applied in advance, the activation signal is emphasized by the Doppler shift. Therefore, the terminal station 3 can demodulate and decode the activation signal. As a result, it is possible to activate the terminal station 3. As described above, in the wireless communication system 1a, even in the case where Doppler shift occurs in the activation signal transmitted from the mobile relay station 2a moving in the sky, it is possible to activate the terminal station 3 installed on the ground.

Furthermore, according to the wireless communication system 1a in the second embodiment, the mobile relay station 2a applies the frequency variation that cancels (compensates for) the Doppler variation to the activation signal in advance, and transmits the activation signal to which the frequency variation is applied to the ground. As a result, even if the Doppler variation occurs in the activation signal received by the terminal station 3 installed on the ground, the Doppler variation is canceled by the frequency variation applied in advance to the activation signal, so that the terminal station 3 can demodulate the activation signal. As described above, in the wireless communication system 1a, even in the case where Doppler variation occurs in the activation signal transmitted from the mobile relay station 2a moving in the sky, it is possible to activate the terminal station 3 installed on the ground.

Furthermore, in the wireless communication system 1a according to the second embodiment, since the mobile relay station 2a sequentially transmits the plurality of activation signals to which the frequency variations in different variation amounts are applied to the ground while switching the activation signals at predetermined intervals, it is possible to cancel (compensate for) Doppler variations of a wider variation amount, and thus it is possible to secure a wider activatable area of the terminal station 3.

In the second embodiment, the configuration has been described in which the mobile relay station 2a determines whether the mobile relay station 2a is in the sky above the data collection area on the basis of the orbit information 231 and the time information. However, the embodiment is not limited to such a configuration, and for example, the mobile relay station 2a may grasp a start time and an end time at which data is collected from the terminal station 3 by uplink communication from the base station 4, and determine to be being in the sky above the data collection area from the start time to the end time.

Note that, in the second embodiment, the case has been described in which a mobile object equipped with the mobile relay station 2a is an LEO satellite, but the mobile object may be another flying object flying in the sky, such as a geostationary satellite, a drone, or a HAPS.

Note that the configuration of the wireless communication system 1 described as a modification of the above-described first embodiment can be combined with the configuration of the wireless communication system 1a in the second embodiment.

According to the above-described embodiment, a wireless communication system includes one or more communication devices (apparatuses) installed on the ground and a wireless communication device (apparatus) that moves. For example, the wireless communication system is the wireless communication system 1 or the wireless communication system 1a in the embodiment, the communication device (apparatus) is the terminal station 3 in the embodiment, and the wireless communication device (apparatus) is the mobile relay station 2 or the mobile relay station 2a in the embodiment.

The above-described wireless communication device (apparatus) includes an activation signal generation unit (an activation signal generator), a frequency variation application unit (a frequency variation applicator), and a transmission unit (a transmitter). For example, the activation signal generation unit is the activation signal generation unit 223 in the embodiment, the frequency variation application unit is the frequency variation application unit 225 in the embodiment, and the transmission unit is the transmission/reception unit 221 in the embodiment.

The above-described activation signal generation unit generates the activation signal for activating one or more communication devices (apparatuses). The above-described frequency variation application unit applies the frequency variation that compensates for time variation in the Doppler shift occurring in the activation signal to the activation signal generated by the activation signal generation unit. The above-described transmission unit transmits the activation signal to which the frequency variation is applied by the frequency variation application unit.

The above-described communication device (apparatus) includes a reception unit (a receptor) and an activation control unit (activation controller). For example, the reception unit is the transmission/reception unit 32 in the embodiment, and the activation control unit is the activation control unit 34 in the embodiment. The above-described reception unit receives the activation signal transmitted from the wireless communication device (apparatus). The activation control unit causes an own device (apparatus) to be in the activated state according to the activation signal received by the reception unit.

Note that, in the above-described wireless communication system, at least one of variation amounts of the frequency variation to be applied to the activation signal may be calculated by subtracting Doppler tolerance indicating a variation range of the variation amount that is allowable for the communication device (apparatus) to demodulate and decode the activation signal from a maximum value of the variation amount of the Doppler variation.

Note that the above-described wireless communication system may further include a variation application control unit (a variation application controller). For example, the variation application control unit is the variation application control unit 242 in the embodiment. The above-described variation application control unit may cause the variation amount of the frequency variation to be applied to the activation signal by the frequency variation application unit to be changed at predetermined intervals.

Note that, in the above-described wireless communication system, the variation amount of the frequency variation changed at the predetermined interval may be calculated by subtracting an odd multiple of the Doppler tolerance from the maximum value of the variation amount of the Doppler variation.

Note that the above-described variation application control unit may cause the variation amount of the frequency variation to be changed such that an area on the ground where activation of the communication device (apparatus) is possible by the activation signal immediately before the variation amount of the frequency variation to be applied is changed and an area on the ground where activation of the communication device (apparatus) is possible by the activation signal immediately after the variation amount of the frequency variation to be applied is changed are not adjacent to each other.

Note that the above-described wireless communication system may further include a frequency shift application unit. For example, the wireless communication system is the wireless communication system 1a in the embodiment, and the frequency shift application unit is the frequency shift application unit 225a in the embodiment. The above-described frequency shift application unit may apply a frequency shift that compensates for the Doppler shift generated in the activation signal to the activation signal generated by the activation signal generation unit.

A part or the entirety of the processing performed by the mobile relay station 2 and the mobile relay station 2a in the above-described embodiments may be implemented by a computer. In that case, a program for implementing the functions may be recorded in a computer-readable recording medium, and the functions may be implemented by loading the program recorded in this recording medium to a computer system, and executing the program. The “computer system” herein includes an OS and hardware such as a peripheral device. In addition, the “computer-readable recording medium” refers to a portable medium such as a flexible disk, a magneto-optical disc, a ROM, or a CD-ROM or a storage device such as a hard disk included in the computer system.

Furthermore, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, the specific configuration is not limited to the embodiments, and includes design and the like within the scope not departing from the gist of the present invention.

### INDUSTRIAL APPLICABILITY

The present invention can be applied to a technology for performing communication with a mobile object equipped with a mobile relay station.

### REFERENCE SIGNS LIST

1, 1a Wireless communication system
2, 2a Mobile relay station
3 Terminal station
4 Base station
21 Antenna
22, 22a Terminal communication unit
23 Storage unit
24, 24a Control unit
25 Base station communication unit
26 Antenna
31 Data storage unit
32 Transmission/reception unit
33 Demodulation unit
34 Activation control unit
35 Antenna
41 Antenna
221 Transmission/reception unit
223 Activation signal generation unit
225 Frequency variation application unit
225a Frequency shift application unit
227 Frequency conversion unit
228 Received waveform recording unit
241 Operation control unit
242 Variation application control unit
242a Shift application control unit

English Translation of

1. A communication device activation method performed by a wireless communication system including one or more communication devices installed on a ground and a wireless communication device that moves, the communication device activation method comprising:
generating an activation signal for activating the one or more communication devices;
applying, to the activation signal generated, a frequency variation that compensates for a Doppler variation indicating a time variation in a Doppler shift that occurs in the activation signal; and
transmitting the activation signal to which the frequency variation is applied from the wireless communication device to the one or more communication devices.

2. The communication device activation method according to claim 1, wherein
at least one of variation amounts of the frequency variation to be applied to the activation signal is calculated by subtracting Doppler tolerance indicating a variation range of the variation amount that is allowable for the communication device to demodulate and decode the activation signal from a maximum value of a variation amount of the Doppler variation.

3. The communication device activation method according to claim 2, further comprising:
changing the variation amount of the frequency variation to be applied to the activation signal at a predetermined interval.

4. The communication device activation method according to claim 3, wherein
the variation amount of the frequency variation changed at the predetermined interval is calculated by subtracting an odd multiple of the Doppler tolerance from the maximum value of the variation amount of the Doppler variation.

5. The communication device activation method according to claim 3, wherein,
the variation amount of the frequency variation is changed such that an area on the ground where activation of the communication device is possible by the activation signal immediately before the variation amount of the frequency variation to be applied is changed and an area on the ground where activation of the communication device is possible by the activation signal immediately after the variation amount of the frequency variation to be applied is changed are not adjacent to each other.

6. The communication device activation method according to claim 1, further comprising:
applying a frequency shift for compensating for a Doppler shift generated in the activation signal to the activation signal generated.

7. A wireless communication system including one or more communication devices installed on a ground and a wireless communication device that moves,
the wireless communication device comprising:
an activation signal generator configured to generate an activation signal for activating the one or more communication devices;
a frequency variation applicator configured to apply, to the activation signal generated by the activation signal generator, a frequency variation that compensates for a time variation in a Doppler shift that occurs in the activation signal; and
a transmitter configured to transmit the activation signal to which the frequency variation is applied by the frequency variation applicator, and
the communication device comprising:
a receptor configured to receive the activation signal transmitted from the wireless communication device; and
an activation controller configured to cause an own device to be in an activated state according to the activation signal received by the receptor.

8. A wireless communication device in a wireless communication system including one or more communication devices installed on a ground and the wireless communication device that moves, the wireless communication device comprising:
an activation signal generator configured to generate an activation signal for activating the one or more communication devices;
a frequency variation applicator configured to apply, to the activation signal generated by the activation signal generator, a frequency variation that compensates for a time variation in a Doppler shift that occurs in the activation signal; and
a transmitter configured to transmit the activation signal to which the frequency variation is applied by the frequency variation applicator.
